(19) United States
(12) Patent Application Publication
(10) Pub. No.: US 2025/0293605 A1
(43) Pub. Date: Sep. 18, 2025

(54) CONTROL IC OF A MULTIPHASE SWITCHING CONVERTER FOR SIGNAL TRANSMISSION IN A POWER SUPPLY SYSTEM

(71) Applicant: Chengdu Monolithic Power Systems Co., Ltd., Chengdu (CN)

(72) Inventor: Wangmiao Hu, Hangzhou (CN)

(21) Appl. No.: 19/077,960

(22) Filed: Mar. 12, 2025

(30) Foreign Application Priority Data
Mar. 13, 2024 (CN) 202410288542.7

(51) Int. Cl. H02M 3/158; H02M 1/00

(52) U.S. Cl. CPC H02M 3/1586; H02M 1/0009

(57) ABSTRACT

A power supply system has a first multiphase switching converter and a second multiphase switching converter. The first multiphase switching converter has a first plurality of switching circuits coupled in parallel and a first control integrated circuit (IC) which controls the first plurality of switching circuits, and the second multiphase switching converter has a second plurality of switching circuits coupled in parallel and a second control IC which controls the second plurality of switching circuits. The first control IC has a first bi-directional input and output pin, and the second control IC has a second bi-directional input and output pin. The first bi-directional input and output pin and the second bi-directional input and output pin are coupled together to transmit information between the first control IC and the second control IC, so that the first multiphase switching converter and the second multiphase switching converter provide power in an interleaved manner.

### CROSS-REFERENCE TO RELATED APPLICATIONS

This application claims the benefit of CN application 202410288542.7, filed on Mar. 13, 2024, and incorporated herein by reference.

### BACKGROUND OF THE INVENTION

### 1. Field of the Invention

The present invention generally relates to electronic circuits, and more particularly, relates to control integrated circuits (ICs).

### 2. Description of Related Art

With the development of high-performance CPUs (Central Processing Units), switching converters with lower output voltage and higher output current are needed, and requirements for better thermal performance and faster transient response are also increasing. Multiphase switching converters are widely used because of their superior performance. A multiphase switching converter has a plurality of switching circuits, each switching circuit being one phase, and output terminals of all the switching circuits are coupled together to provide an output voltage for a load.

A controller for a multiphase switching converter usually provides an individual switching control signal for each phase. However, if the number of the phases is larger than the number of switching control signals that the controller can provide, then it will be necessary to use one switching control signal to control two or more phases, which may cause new problems.

### SUMMARY OF THE INVENTION

Embodiments of the present invention are directed to a control integrated circuit (IC) of a multiphase switching converter. The control IC comprises a bi-directional input and output pin, a voltage sense pin, and a plurality of switching control pins. The bi-directional input and output pin is operable to be coupled to additional control ICs of additional multiphase switching converters to transmit a communication signal, for activating the multiphase switching converter and the additional multiphase switching converters to provide power in an interleaved manner. The voltage sense pin is configured to receive a voltage sense signal representing an output voltage of the multiphase switching converter. The plurality of switching control pins are configured to be respectively coupled to a plurality of switching circuits of the multiphase switching converter. The control IC is configured to provide a plurality of switching control signals via the plurality of switching control pins based on the voltage sense signal to successively turn on the plurality of switching circuits during a time period when the multiphase switching converter is activated to provide power. The communication signal comprises an identification pulse and a synchronizing pulse, wherein the identification pulse is configured to transmit identity information of one of the control IC and the additional control ICs which is currently working, and the synchronizing pulse is configured to inform another one of the control IC and the additional control ICs to activate a corresponding one of the multiphase switching converter and the additional multiphase switching converters.

Embodiments of the present invention are directed to a control IC of a multiphase switching converter. The control IC comprises a bi-directional input and output pin, a first communication pin, a second communication pin, a voltage sense pin, a plurality of switching control pins, and a switching control circuit. The bi-directional input and output pin is operable to be coupled to additional control ICs of additional multiphase switching converters to transmit a communication signal, for activating the multiphase switching converter and the additional multiphase switching converters to provide power in an interleaved manner. The first communication pin is configured to receive a command. The second communication pin is configured to receive a voltage identification code. The voltage sense pin is configured to receive a voltage sense signal representing an output voltage of the multiphase switching converter. The plurality of switching control pins are configured to be respectively coupled to a plurality of switching circuits of the multiphase switching converter to output a plurality of switching control signals, so as to successively turn on the plurality of switching circuits during a time period when the multiphase switching converter is activated. The switching control circuit is coupled to the plurality of switching control pins to provide the plurality of switching control signals based on the command, the voltage sense signal, and the voltage identification code.

Embodiments of the present invention are directed to a control method for power supply system. The power supply system comprises a first multiphase switching converter and a second multiphase converter coupled in parallel to provide an output voltage. The control method comprises transmitting a communication signal between a first control IC of the first multiphase switching converter and a second control IC of the second multiphase switching converter, to activate the first multiphase switching converter and the second multiphase switching converter to provide power in an interleaved manner, receiving a voltage sense signal representing the output voltage by the first control IC and the second control IC, providing a first plurality of switching control signals by the first control IC to successively turn on a first plurality of switching circuits of the first multiphase switching converter, providing a second plurality of switching control signals by the second control IC to successively turn on a second plurality of switching circuits of the second multiphase switching converter, receiving a voltage identification code by the first control IC and the second control IC for adjusting the output voltage, providing the first plurality of switching control signals based on the voltage sense signal and the voltage identification code during a time period when the first multiphase switching converter is activated to provide power, and providing the second plurality of switching control signals based on the voltage sense signal and the voltage identification code during a time period when the second multiphase switching converter is activated to provide power.

Embodiments of the present invention are directed to a power supply system, comprising a first multiphase switching converter and a second multiphase switching converter. The first multiphase switching converter comprises a first plurality of switching circuits coupled in parallel and a first control IC. The first control IC comprises a first bi-directional input and output pin and a first plurality of switching control pins. The first plurality of switching control pins are configured to provide a first plurality of switching control signals to control the first plurality of switching circuits. The second multiphase switching converter comprises a second plurality of switching circuits coupled in parallel and a second control IC. The second control IC comprises a second bi-directional input and output pin and a second plurality of switching control pins. The second plurality of switching control pins are configured to provide a second plurality of switching control signals to control the second plurality of switching circuits. The first bi-directional input and output pin and the second bi-directional input and output pin are coupled together to transmit information between the first control IC and the second control IC for controlling the first multiphase switching converter and the second multiphase switching converter to provide power in an interleaved manner.

These and other features of the present invention will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically shows a circuit diagram of a power supply system 100 in accordance with an embodiment of the present invention.

FIG. 2 schematically shows a diagram 20 of controller integrated circuits (ICs) 10_1-10_3 in accordance with an embodiment of the present invention.

FIG. 3 shows waveforms of the power supply system 100 in accordance with an embodiment of the present invention.

FIG. 4 schematically shows a circuit diagram of a multiphase switching converter 1001 in accordance with an embodiment of the present invention.

FIG. 5 schematically shows a circuit diagram of the control IC 10_1 in accordance with an embodiment of the present invention.

FIG. 6 shows waveforms of the control IC 10_1 in accordance with an embodiment of the present invention.

FIG. 7 schematically shows a circuit diagram of a multiphase switching converter 2001 in accordance with another embodiment of the present invention.

FIG. 8 schematically shows a circuit diagram of a power IC 80 in accordance with an embodiment of the present invention.

FIG. 9 illustrates a control method 91 for a multiphase switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

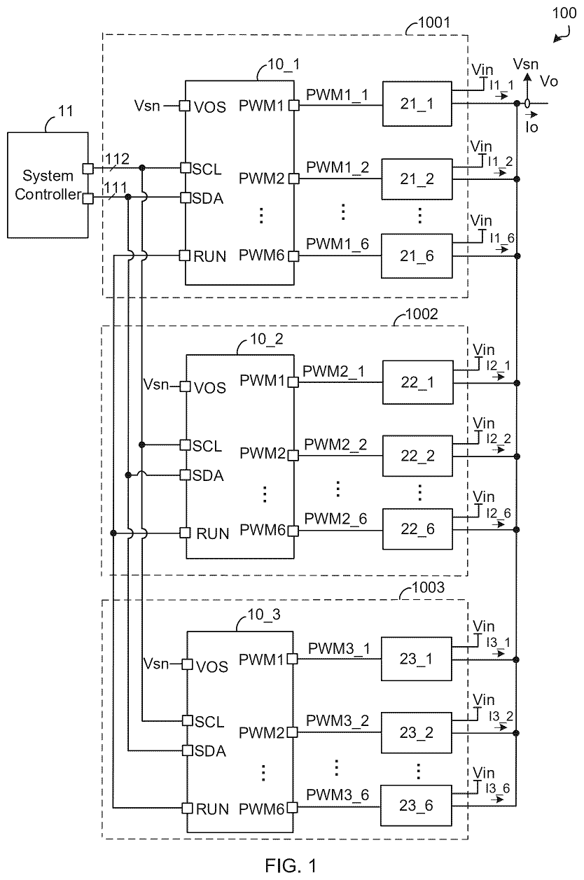

FIG. 1 schematically shows a circuit diagram of a power supply system 100 in accordance with an embodiment of the present invention. The power supply system 100 receives an input voltage Vin and provides an output voltage Vo and an output current Io. The power supply system 100 has a plurality of control integrated circuits (ICs) 10_1-10_3 and a power circuit having switching circuits 21_1-21_6, 22_1-22_6, and 23_1-23_6 coupled in parallel. The power circuit is configured to receive the input voltage Vin and provide the output voltage Vo. The control IC 10_1 provides a plurality of switching control signals PWM1_1-PWM1_6 to turn on and off the switching circuits 21_1-21_6, the control IC 10_2 provides a plurality of switching control signals PWM2_1-PWM2_6 to turn on and off the switching circuits 22_1-22_6, and the control IC 10_3 provides a plurality of switching control signals PWM3_1-PWM3_6 to turn on and off the switching circuits 23_1-23_6. FIG. 1 is illustrated by employing three control ICs as one example, and one with ordinary skill in the art should understand that the power supply system 100 may also have two or more than three control ICs. The control IC 10_1 and the switching circuits 21_1-21_6 form a multiphase switching converter 1001, the control IC 10_2 and the switching circuits 22_1-22_6 form a multiphase switching converter 1002, and the control IC 10_3 and the switching circuits 23_1-23_6 form a multiphase switching converter 1003. In the embodiment of FIG. 1, the switching circuits 21_1-21_6 provides currents I1_1-I1_6 respectively, the switching circuits 22_1-22_6 provides currents I2_1-I2_6 respectively, and the switching circuits 23_1-23_6 provides currents I3_1-I3_6 respectively. In some embodiments, the switching circuits 21_1-21_6, 22_1-22_6, and 23_1-23_6 may comprise buck circuits, boost circuits or buck-boost circuits, etc. One with ordinary skill in the art should understand that each of the control IC 10_i (i=1, 2, 3) may also control more or fewer switching circuits, i.e., the number of switching circuits controlled by each control IC 10_i is not limited by the embodiment of FIG. 1. Furthermore, although each control IC 10_i in the embodiment of FIG. 1 controls a same number of switching circuits, one with ordinary skill in the art should understand that each control IC 10_i may also control different numbers of switching circuits.

In the example of FIG. 1, each control IC 10_i (i=1, 2, 3) has a voltage sense pin VOS, a bi-directional input and output pin RUN, a clock pin SCL, a communication pin SDA, and a plurality of switching control pins PWM1-PWM6. The voltage sense pin VOS of each control IC 10_i is configured to receive a voltage sense signal Vsn representing the output voltage Vo. The bi-directional input and output pin RUN of each control IC 10_i is configured for bi-directional signal transmission. To be specific, the bi-directional input and output pins RUN of the control ICs 10_1-10_3 are coupled together to transmit information among all the control ICs 10_1-10_3 (e.g., by transmitting signals), so that the plurality of multiphase switching converters 1001-1003 are configured to work together to provide the output voltage Vo. The clock pins SCL of all the control ICs 10_1-10_3 are coupled together to the system controller 11 through a clock bus 112. The communication pins SDA of all the control ICs 10_1-10_3 are coupled together to the system controller 11 through a data bus 111. Therefore, the control ICs 10_1-10_3 receive commands from the system controller 11 and thus configure circuit parameters under the control of the system controller 11. In one embodiment, the data bus 111 may comprise Inter-Integrated Circuit Bus (I2C Bus), System Management Bus (SMBus), and Power Management Bus (PMBus), etc. In one embodiment, the system controller 11 may comprise a baseboard management controller (BMC) or a test controller provided by an IC supplier. One with ordinary skill in the art should understand that each control IC 10_i may also be coupled to the system controller 11 through other communication buses.

The plurality of switching control pins PWM1-PWM6 of each controller 10_i (i=1, 2, 3) are configured to provide the plurality of switching control signals PWMi_1-PWMi_6 to turn on the plurality of switching circuits 2i_1-2i_6 successively. For example, the control IC 10_1 outputs the plurality of switching control signals PWM1_1-PWM1_6 via its switching control pins PWM1-PWM6 based on the voltage sense signal Vsn and the commands from the system controller 11 to turn on the switching circuits 21_1-21_6 successively. The control IC 10_2 outputs the plurality of switching control signals PWM2_1-PWM2_6 via its switching control pins PWM1-PWM6 based on the voltage sense signal Vsn and the commands from the system controller 11 to turn on the switching circuits 22_1-22_6 successively. The control IC 10_3 outputs the plurality of switching control signals PWM3_1-PWM3_6 via its switching control pins PWM1-PWM6 based on the voltage sense signal Vsn and the commands from the system controller 11 to turn on the switching circuits 23_1-23_6 successively. In some examples, the commands from the system controller 11 may comprise enabling or disabling the plurality of switching control signals, and adjusting an on-time of each switching circuit by adjusting the corresponding switching control signal, etc.

Embodiments of the present invention provide the power supply system 100, in which the bi-directional input and output pins RUN of the control ICs 10_1-10_3 are coupled together to transmit information among the control ICs 10_1-10_3. Thus the plurality of multiphase switching converters 1001-1003 are configured to work together to provide the output voltage Vo, and the output current Io provided by the power supply system 100 could be increased. Besides, each switching circuit is ensured to be independently driven by a single switching control signal. Therefore, the circuit of the power supply system 100 shows better reliability without additional communication pins.

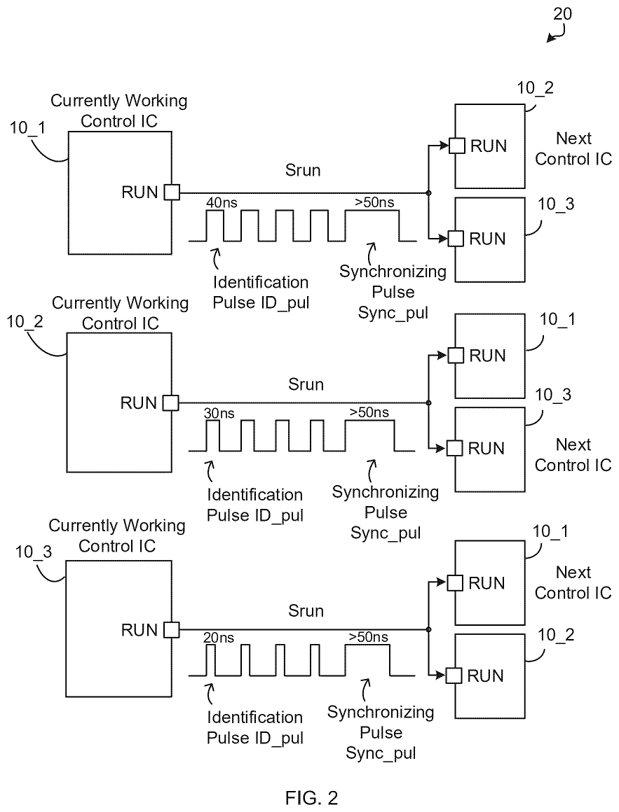

FIG. 2 schematically shows a diagram 20 of the control ICs 10_1-10_3 in accordance with an embodiment of the present invention. In the embodiment of FIG. 2, each control IC 10_i (i=1, 2, 3) is configured to output or receive a communication signal Srun via its bi-directional input and output pins RUN, and the communication signal Srun is configured to activate the plurality of multiphase switching converters 1001-1003 to provide power in an interleaved manner. In one embodiment, the communication signal Srun on the bi-directional input and output pins RUN comprises an identification pulse ID_pul. The identification pulse ID_pul indicates that which control IC is currently working (i.e., which control IC is controlling one of the multiphase switching converters 1001-1003 to provide power). For example, the identification pulse ID_pul may represent identity information (e.g., a serial number or an address) of the currently working control IC, so that other control ICs identify the currently working control IC. In one embodiment, the communication signal Srun on the bi-directional input and output pins RUN comprises a synchronizing pulse Sync_pul. The synchronizing pulse Sync_pul is configured to transfer the currently working multiphase switching converter to a next multiphase switching converter controlled by a next control IC, i.e., the synchronizing pulse Sync_pul is configured to inform the next control IC to control the corresponding multiphase switching converter to provide power.

In one embodiment, when the control IC 10_1 is currently working to control the power supply system 100 to provide power, the control IC 10_1 successively outputs the switching control signals PWM1_1-PWM1_6 in a first status to turn on the switching circuits 21_1-21_6 successively, so that the multiphase switching converter 1001 provides power. During a time period when the multiphase switching converter 1001 provides power, the control IC 10_1 outputs an identification pulse ID_pul with a first feature on its bi-directional input and output pin RUN to indicate that the control IC 10_1 is currently working, for example but not limited to, providing a pulse with a first pulse width (40 ns as shown in FIG. 2). Meanwhile, the control ICs 10_2 and 10_3 control the corresponding multiphase switching converters 1002 and 1003 to pause providing power. The control ICs 10_2 and 10_3 respectively receive the identification pulse ID_pul with the first feature on their bi-directional input and output pins RUN and identify that the control IC 10_1 is currently working. Thus, the control IC 10_2 is ready to be the next control IC which will control the multiphase switching converter 1002 to provide power. Before the control IC 10_2 being the currently working control IC (i.e., before the multiphase switching converter 1002 is activated), the control IC 10_1 outputs the synchronizing pulse Sync_pul which satisfies a preset condition to inform the next control IC (i.e., the control IC 10_2) to control the corresponding multiphase switching converter (i.e., the multiphase switching converter 1002) to provide power. The control IC 10_2 then becomes the currently working control IC (i.e., the control IC 10_2 controls the multiphase switching converter 1002 to provide power) in response to the synchronizing pulse Sync_pul which satisfies the preset condition. For example, the multiphase switching converter 1002 starts providing power once a next switching cycle starts, and the multiphase switching converter 1001 pauses providing power after its switching cycle completed. During a time period when the multiphase switching converter 1002 or the multiphase switching converter 1003 provides power, the control IC 10_1 receives the identification pulse ID_pul and/or the synchronizing pulse Sync_pul provided by the control IC 10_2 or the control IC 10_3 on its bi-directional input and output pin RUN.

In one embodiment, when the control IC 10_2 is currently working to control the power supply system 100 to provide power, the control IC 10_2 successively outputs the switching control signals PWM2_1-PWM2_6 in the first status to turn on the switching circuits 22_1-22_6 successively, so that the multiphase switching converter 1002 provides power. During a time period when the multiphase switching converter 1002 provides power, the control IC 10_2 outputs an identification pulse ID_pul with a second feature on its bi-directional input and output pin RUN to indicate that the control IC 10_2 is currently working, for example but not limited to, providing a pulse with a second pulse width (30 ns as shown in FIG. 2). Meanwhile, the control ICs 10_1 and 10_3 control the corresponding multiphase switching converters 1001 and 1003 to pause providing power. The control ICs 10_1 and 10_3 respectively receive the identification pulse ID_pul with the second feature on their bi-directional input and output pins RUN and identify that the control IC 10_2 is currently working. Thus, the control IC 10_3 is ready to be the next control IC which will control the multiphase switching converter 1003 to provide power. Before the control IC 10_3 being the currently working control IC (i.e., before the multiphase switching converter 1003 is activated), the control IC 10_2 outputs the synchronizing pulse Sync_pul which satisfies the preset condition to inform the next control IC (i.e., the control IC 10_3) to control the corresponding multiphase switching converter (i.e., the multiphase switching converter 1003) to provide power. The control IC 10_3 then becomes the currently working control IC (i.e., the control IC 10_3 controls the multiphase switching converter 1003 to provide power) in response to the synchronizing pulse Sync_pul which satisfies the preset condition. For example, the multiphase switching converter 1003 starts providing power once a next switching cycle starts, and the multiphase switching converter 1002 pauses providing power after its switching cycle completed. During a time period when the multiphase switching converter 1001 or the multiphase switching converter 1003 provides power, the control IC 10_2 receives the identification pulse ID_pul and/or the synchronizing pulse Sync_pul provided by the control IC 10_1 or the control IC 10_3 on its bi-directional input and output pin RUN.

In one embodiment, when the control IC 10_3 is currently working to control the power supply system 100 to provide power, the control IC 10_3 successively outputs the switching control signals PWM3_1-PWM3_6 in the first status to turn on the switching circuits 23_1-23_6 successively, so that the multiphase switching converter 1003 provides power. During a time period when the multiphase switching converter 1003 provides power, the control IC 10_3 outputs an identification pulse ID_pul with a third feature on its bi-directional input and output pin RUN to indicate that the control IC 10_3 is currently working, for example but not limited to, providing a pulse with a third pulse width (20 ns as shown in FIG. 2). Meanwhile, the control ICs 10_1 and 10_2 control the corresponding multiphase switching converters 1001 and 1002 to pause providing power. The control ICs 10_1 and 10_2 respectively receive the identification pulse ID_pul with the second feature on their bi-directional input and output pins RUN and identify that the control IC 10_3 is currently working. Thus, the control IC 10_1 is ready to be the next control IC which will control the multiphase switching converter 1001 to provide power. Before the control IC 10_1 being the currently working control IC (i.e., before the multiphase switching converter 1003 is activated), the control IC 10_3 outputs the synchronizing pulse Sync_pul which satisfies the preset condition to inform the next control IC (i.e., the control IC 10_1) to control the corresponding multiphase switching converter (i.e., the multiphase switching converter 1001) to provide power. The control IC 10_1 then becomes the currently working control IC (i.e., the control IC 10_1 controls the multiphase switching converter 1001 to provide power) in response to the synchronizing pulse Sync_pul which satisfies the preset condition. For example, the multiphase switching converter 1001 starts providing power once a next switching cycle starts, and the multiphase switching converter 1003 pauses providing power after its switching cycle completed. During a time period when the multiphase switching converter 1001 or the multiphase switching converter 1002 provides power, the control IC 10_3 receives the identification pulse ID_pul and/or the synchronizing pulse Sync_pul provided by the control IC 10_1 or the control IC 10_2 on its bi-directional input and output pin RUN.

In one embodiment, the synchronizing pulse Sync_pul which satisfies the preset condition has a fourth feature. For example, the synchronizing pulse Sync_pul may have a pulse width larger than a duration threshold (e.g., 50 ns). However, the present invention is not limited thereto. The embodiments of the present invention are illustrated by employing three control ICs as one example, and one with ordinary skill in the art should understand that the power supply system 100 may also comprise more or fewer control ICs coupled together via their bi-directional input and output pins RUN to control the plurality of multiphase switching converters to provide power successively.

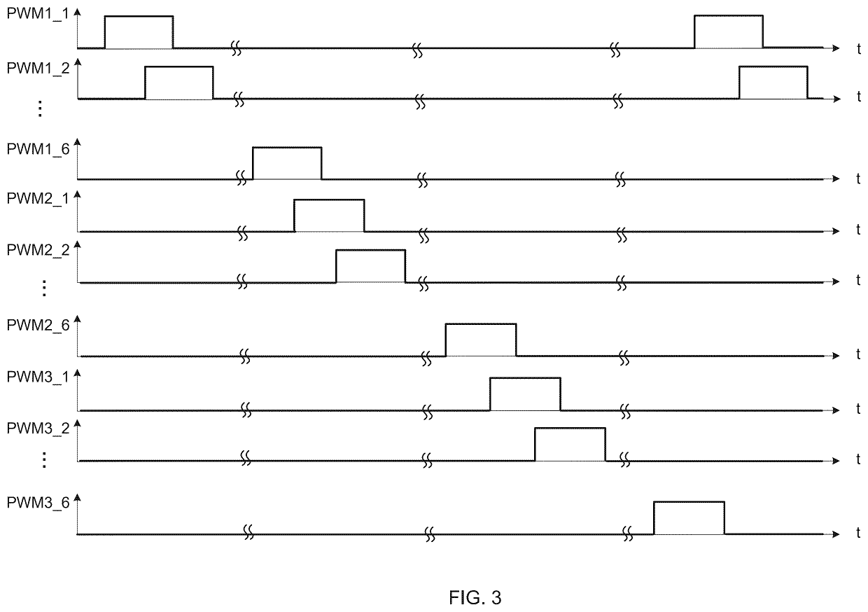

FIG. 3 shows waveforms of the power supply system 100 in accordance with an embodiment of the present invention. From top to bottom, FIG. 3 shows the switching control signals PWM1_1-PWM1_6, the switching control signals PWM2_1-PWM2_6, and the switching control signals PWM3_1-PWM3_6. In the example of FIG. 3, a switching control signal turns on the corresponding switching circuit when at a high voltage level, and turns off the corresponding switching circuit when at a low voltage level. In one embodiment, a voltage level between a high threshold voltage (e.g. 2V) and the voltage source VCC (e.g. 3.3V) is considered as the high voltage level, a voltage level between zero voltage (0 V) and a low threshold voltage (e.g. 1V) is considered as the low voltage level.

In the embodiment of FIG. 3, the switching circuits 21_1-21_6 are successively turned on by the switching control signals PWM1_1-PWM1_6. After the switching circuit 21_6 being turned on by the switching control signal PWM1_6, the switching circuits 22_1-22_6 are successively turned on by the switching control signals PWM2_1-PWM2_6. After the switching circuit 22_6 being turned on by the switching control signal PWM2_6, the switching circuits 23_1-23_6 are successively turned on by the switching control signals PWM3_1-PWM3_6. After the switching circuit 23_6 being turned on by the switching control signal PWM3_6, the switching circuits 21_1-21_6 are successively turned on by the switching control signals PWM1_1-PWM1_6. This operation repeats and the multiphase switching converters 1001-1003 output power in the interleaved manner.

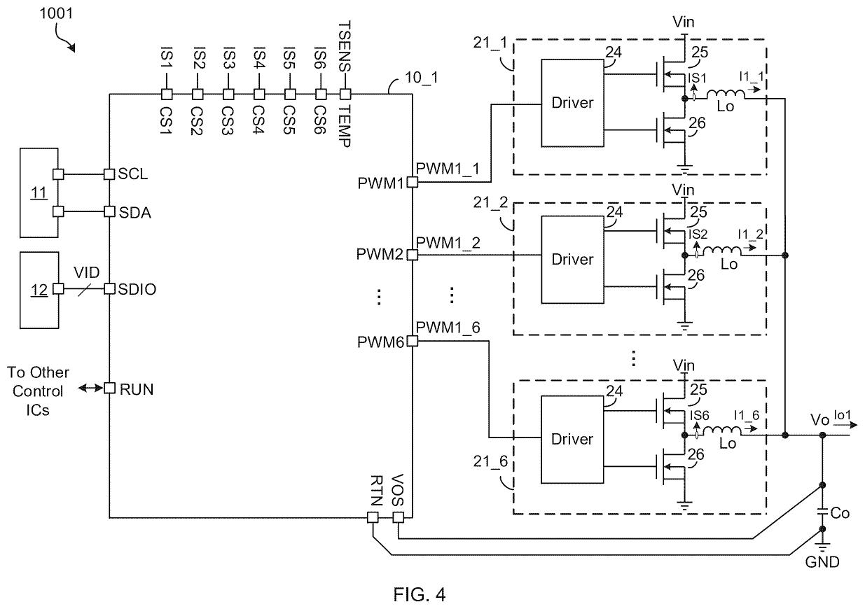

FIG. 4 schematically shows a circuit diagram of the multiphase switching converter 1001 in accordance with an embodiment of the present invention. The embodiment of FIG. 4 is illustrated by employing the multiphase switching converter 1001 as an example, circuit diagrams of the multiphase switching converters 1002-1003 are similar to the circuit diagram of the multiphase switching converter 1001 and are not described here for brevity.

The multiphase switching converter 1001 has the control IC 10_1 and the switching circuits 21_1-21_6. In the example of FIG. 4, each of the switching circuits 21_1-21_6 has a driver 24, a high side switch 25, a low side switch 26, and an output inductor Lo. In each switching circuit 21_j (j=1, 2, . . . , 6), the high side switch 25 has a first terminal receiving the input voltage Vin and a second terminal coupled to the output inductor Lo. The low side switch 26 has a first terminal coupled to the second terminal of the high side switch 25 and the output inductor Lo, and a second terminal coupled to a reference ground GND. An output capacitor Co is coupled between the output inductors Lo and the reference ground GND to provide the output voltage Vo. The current I1_1 provided by the switching circuit 21_1 is a current flowing through the output inductor Lo of the switching circuit 21_1, the current I1_2 provided by the switching circuit 21_2 is a current flowing through the output inductor Lo of the switching circuit 21_2, and so on. The driver circuits 24 receive corresponding switching control signals and drive the high side switches 25 and the low side switches 26 based on the switching control signals. For example, the driver circuit 24 of the switching circuit 21_1 drives the high side switch 25 and the low side switch 26 of the switching circuit 21_1 based on the switching control signal PWM1_1, the driver circuit 24 of the switching circuit 21_2 drives the high side switch 25 and the low side switch 26 of the switching circuit 21_2 based on the switching control signal PWM1_2, and so on. In one embodiment, the driver 24 of the switching circuit 21_j is integrated in one integrated circuit (IC), and in another embodiment, the driver 24, the high side switch 25, and the low side switch 26 of the switching circuit 21_j are integrated in one IC.

In one embodiment, the control IC 10_1 further has phase current sense pins CS1-CS6 to receive current sense signals IS1-IS6. The current sense signals IS1-IS6 represent the currents I1_1-I1_6 flowing through the switching circuits 21_1-21_6 respectively. In one embodiment, the control IC 10_1 further has a temperature sense pin TEMP to receive a temperature sense signal TSENS which monitors a temperature of the multiphase switching converter 1001. In some examples, the temperature sense signal TSENS may represent a temperature of each switching circuit 21_j (j=1, 2, . . . , 6) and/or a highest temperature of the switching circuits 21_1-21_6. In one embodiment, the control IC 10_1 further has a voltage return pin RTN. The voltage sense pin VOS is coupled to a first terminal of the output capacitor Co, and the voltage return pin RTN is coupled to a second terminal of the output capacitor Co. A voltage between the voltage sense pin VOS and the voltage return pin RTN is the voltage sense signal Vsn which represents the output voltage Vo.

In one embodiment, the control IC 10_1 further has a communication pin SDIO coupled to a processor 12, and the communication pin SDIO is configured to receive power requirements of the processor 12. For example, the communication pin SDIO receives a voltage identification code VID to set a target output voltage of the power supply system 100. In one embodiment, the power supply system 100 supplies power to the processor 12 (e.g., by providing the output voltage Vo and the output current Io), i.e., the processor 12 is a load of the power supply system 100.

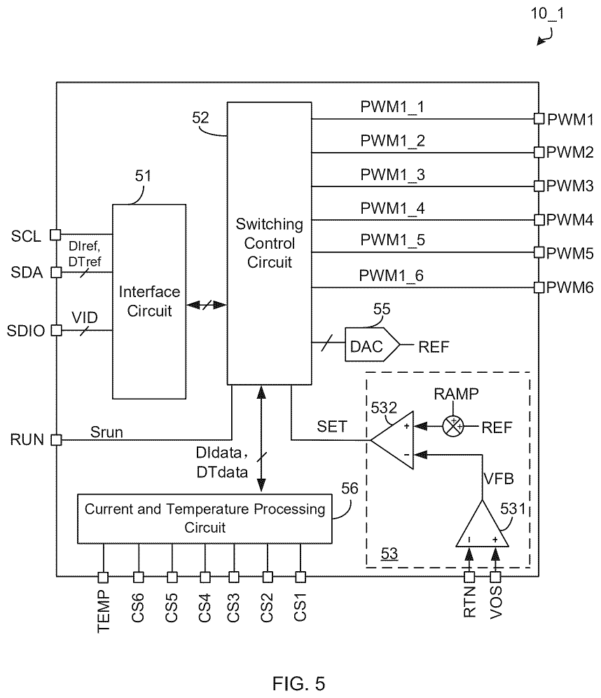

FIG. 5 schematically shows a circuit diagram of the control IC 10_1 in accordance with an embodiment of the present invention. In the example of FIG. 5, the control IC 10_1 has an interface circuit 51, a switching control circuit 52, and a comparison circuit 53.

In one embodiment, the interface circuit 51 is coupled to the system controller 11 shown in FIG. 4 via the communication pin SDA and the clock pin SCL of the control IC 10_1 to receive the commands provided by the system controller 11. The switching control circuit 52 configures circuit parameters based on the commands from the system controller 11. For example, the switching control circuit 52 enables the multiphase switching converter 1001, and configures the switching cycle, startup sequence, power off sequence, a current protection threshold, a voltage protection threshold, a temperature protection threshold, and the number of switching circuits providing power at the same time, etc. The switching control circuit 52 further adjusts the switching control signals PWM1_1-PWM1_6 based on the configurations above. In one embodiment, the interface circuit 51 further receives the voltage identification code VID via the communication pin SDIO to set the target output voltage. The control IC 10_1 sets the target output voltage based on the voltage identification code VID.

In one embodiment, the control IC 10_1 works together with other control ICs to control a plurality of multiphase switching converters (i.e., the multiphase switching converter 1001 and other multiphase switching converters controlled by the other control ICs) to provide the output voltage Vo together. During the time period when the multiphase switching converter 1001 provides power under the control of the control IC 10_1, the switching control circuit 52 provides the plurality of switching control signals PWM1_1-PWM1_6 based on the commands from the system controller 11, the voltage sense signal Vsn between the voltage sense pin VOS and the voltage return pin RTN, and the voltage identification code VID, and thus controls the output voltage Vo equal to the target output voltage set by the voltage identification code VID. In some examples, the switching control circuit 52 may employ constant on time control, adaptive on time control, peak current control, voltage control, and other suitable control schemes.

In one embodiment, when the control IC 10_1 is configured to be a master control IC, the control IC 10_1 provides a current reference data DIref via its communication pin SDA to adjust output currents of the multiphase switching converters controlled by the other control ICs. In one embodiment, when the control IC 10_1 is configured to be a slave control IC, the control IC 10_1 receives the current reference data DIref provided by the master control IC via its communication pin SDA and adjusts an output current Io1 of the multiphase switching converter 1001 by providing the switching control signals PWM1_1-PWM1_6 based on the current reference data DIref.

In one embodiment, when the control IC 10_1 is configured to be the master control IC, the control IC 10_1 provides a temperature reference data DTref via its communication pin SDA to adjust the temperatures of the multiphase switching converters controlled by the other control ICs. In one embodiment, when the control IC 10_1 is configured to be the slave control IC, the control IC 10_1 receives the temperature reference data DTref provided by the master control IC via its communication pin SDA and adjusts the temperature of the multiphase switching converter 1001 based on the temperature reference data DTref.

In one embodiment, the control IC 10_1 further has a current and temperature processing circuit 56. The current and temperature processing circuit 56 is coupled to the phase current sense pins CS1-CS6 and the temperature sense pin TEMP of the control IC 10_1, and provides a current sense data DIdata and a temperature sense data DTdata to the switching control circuit 52 based on the current sense signals IS1-IS6 received by the phase current sense pins CS1-CS6 and the temperature sense signal TSENS received by the temperature sense pin TEMP (e.g., by digital to analog conversion). The switching control circuit 52 further balances the currents I1_1-I1_6 of the switching circuits 21_1-21_6 and achieves thermal balance or thermal management among the switching circuits 21_1-21_6 by adjusting the switching control signals PWM1_1-PWM1_6 based on the current sense data DIdata representing the current sense signals IS1-IS6 and the temperature sense data DTdata representing the temperature sense signal TSENS.

In one embodiment, when the control IC 10_1 is configured to be the master control IC, the control IC 10_1 provides the current reference data DIref to the other control ICs via its communication pin SDA based on the current sense signals IS1-IS6. In one embodiment, when the control IC 10_1 is configured to be the slave control IC, the control IC 10_1 receives the current reference data DIref provided by the master control IC via its communication pin SDA, and the switching control circuit 52 adjusts the currents I1_1-I1_6 of the switching circuits 21_1-21_6 by adjusting the switching control signals PWM1_1-PWM1_6 based on the current reference data DIref and the current sense data DIdata, so that the output current Io1 of the multiphase switching converter 1001 is consistent with the reference current represented by the current reference data DIref. For example, the switching control circuit 52 adjusts on time periods or duty ratios of the switching circuits 21_1-21_6 by using the switching control signals PWM1_1-PWM1_6, and thus adjusts the currents I1_1-I1_6 of the switching circuits 21_1-21_6 and the output current Io1 of the multiphase switching converter 1001.

In one embodiment, when the control IC 10_1 is configured to be the master control IC, the control IC 10_1 provides the temperature reference data DTref to the other control ICs via its communication pin SDA based on the temperature sense signal TSENS. In one embodiment, when the control IC 10_1 is configured to be the slave control IC, the control IC 10_1 receives the temperature reference data DTref provided by the master controller, and the switching control circuit 52 adjusts the output power of the switching circuits 21_1-21_6 by adjusting the switching control signals PWM1_1-PWM1_6 based on the temperature reference data DTref and the temperature sense data DTdata, so that the temperature of the multiphase switching converter 1001 is adjusted to be consistent with a reference temperature represented by the temperature reference data DTref. For example, the switching control circuit 52 adjusts the on times or the duty ratios of the switching circuits 21_1-21_6 by using the switching control signals PWM1_1-PWM1_6, and thus adjusts the output power of the switching circuits 21_1-21_6.

In one embodiment, the comparison circuit 53 generates a set signal SET based on a voltage reference signal REF and the voltage sense signal Vsn representing the output voltage Vo. In one embodiment, the switching control circuit 52 provides the voltage reference signal REF based on the voltage identification code VID. In one embodiment, when the control IC 10_1 is the currently working control IC, the control IC 10_1 controls the switching control signals PWM1_1-PWM1_6 to be in the first status (i.e., asserted) successively based on the set signal SET. For example, the switching control signals PWM1_1-PWM1_6 transits to the high voltage level successively. In the example of FIG. 5, the comparison circuit 53 comprises a differential amplifier circuit 531 and a comparator 532. An input terminal of the differential amplifier circuit 531 is coupled to the voltage sense pin VOS and the voltage return pin RTN, and the differential amplifier circuit 531 provides a feedback signal VFB based on the differential voltage between the voltage sense pin VOS and the voltage return pin RTN. The comparator 532 provides the set signal SET based on the feedback signal VFB and the voltage reference signal REF. In one embodiment, the comparator 532 provides the set signal SET based on the feedback signal VFB, the voltage reference signal REF, and a ramp signal RAMP. In one embodiment, the control IC 10_1 further has a digital to analog converter 55. The switching control circuit 52 provides the voltage reference signal REF based on the voltage identification code VID using the digital to analog converter 55.

In one embodiment, the switching control circuit 52 receives the communication signal Srun via the bi-directional input and output pin RUN or outputs the communication signal Srun on the bi-directional input and output pin RUN. During the time period when the multiphase switching converter 1001 provides power, the switching control circuit 52 outputs the communication signal Srun on the bi-directional input and output pin RUN of the control IC 10_1. In one embodiment, in response to at least one switching circuit 21_j (j=1, 2, . . . , 6) being turned on by a corresponding switching control signal PWM1_j (j=1, 2, . . . , 6), the control IC 10_1 provides the identification pulse ID_pul on the bi-directional input and output pin RUN. In other words, in response to the first status of at least one switching control signal PWM1_j, e.g., in response to the switching control signal PWM1_1 which is at the high voltage level, the communication signal Srun provided by the switching control circuit 52 comprises the identification pulse ID_pul to indicate that the control IC 10_1 is currently working to control the multiphase switching converter 1001 to provide power. In one embodiment, before the currently working control IC (i.e., the control IC 10_1) is transferred to the next control IC (i.e., the control IC 10_2), the communication signal Srun provided by the switching control circuit 52 of the control IC 10_1 comprises the synchronizing pulse Sync_pul to inform the next control IC (i.e., the control IC 10_2) to control the corresponding multiphase switching converter (i.e., the multiphase switching converter 1002) to provide power. For example, in response to at least a last switching circuit 21_j being turned on by a corresponding switching control signal 21_j, i.e., in response to the first status of at least the last switching control signal (e.g., the switching control signal PWM1_6 which is at the high voltage level), or in response to all the switching circuits 21_1-21_6 having successively output power, the switching control circuit 52 of the control IC 10_1 provides the synchronizing pulse Sync_pul on the bi-directional input and output pin RUN. During the time period when the multiphase switching converter 1001 pauses providing power, e.g., during a time period when the other multiphase switching converters provide power, the switching control circuit 52 of the control IC 10_1 receives the communication signal Srun provided by the other control ICs on the bi-directional input and output pin RUN.

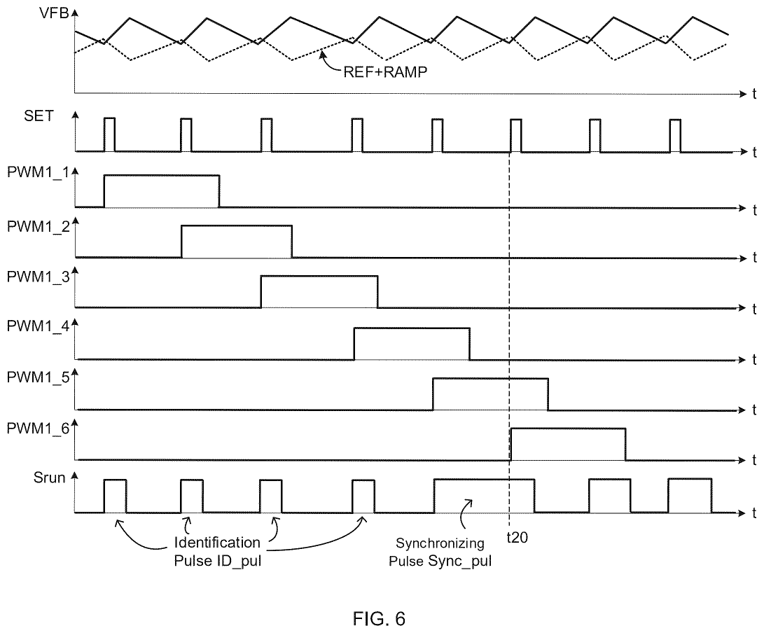

FIG. 6 shows waveforms of the control IC 10_1 in accordance with an embodiment of the present invention. FIG. 6 shows, from top to bottom, the feedback signal VFB, the set signal SET, the switching control signals PWM1_1-PWM1_6, and the communication signal Srun on the bi-directional input and output pin RUN of the control IC 10_1. In the example of FIG. 6, when the feedback signal VFB is smaller than a sum of the voltage reference signal REF and the ramp signal RAMP (i.e., REF+RAMP), the set signal SET transits to the high voltage level. Before the time t20, the multiphase switching converter 1001 provides power, and the switching control signals PWM1_1-PWM1_6 transits to the high voltage level successively to turn on the switching circuits 21_1-21_6 successively under the control of the set signal SET which is at the high voltage level. After the last switching circuit 21_6 of the multiphase switching converter 1001 is turned on, i.e., after the time t20, the set signal SET which is at the high voltage level has no effect on the multiphase switching converter 1001, and the switching control signals PWM1_1-PWM1_6 remain at the low voltage level, i.e., the switching circuits 21_1-21_6 remain off.

In the example of FIG. 6, in response to the switching control signals PWM1_1-PWM1_4 transiting to the high voltage level to turn on the corresponding switching circuits 21_1-21_4, the control IC 10_1 provides the identification pulse ID_pul on its bi-directional input and output pin RUN to indicate that the multiphase switching converter 1001 is currently working to provide power under the control of the control IC 10_1. The control IC 10_1 starts to provide the synchronizing pulse Sync_pul on the bi-directional input and output pin RUN in response to the switching control signal PWM1_5 transiting to the high voltage level to turn on the corresponding switching circuits 21_5, so that the synchronizing pulse Sync_pul can have a sufficient pulse width when at a high switching frequency. After the time t20, the control IC 10_1 receives the communication signal Srun provided by the other control ICs via its bi-directional input and output pin RUN.

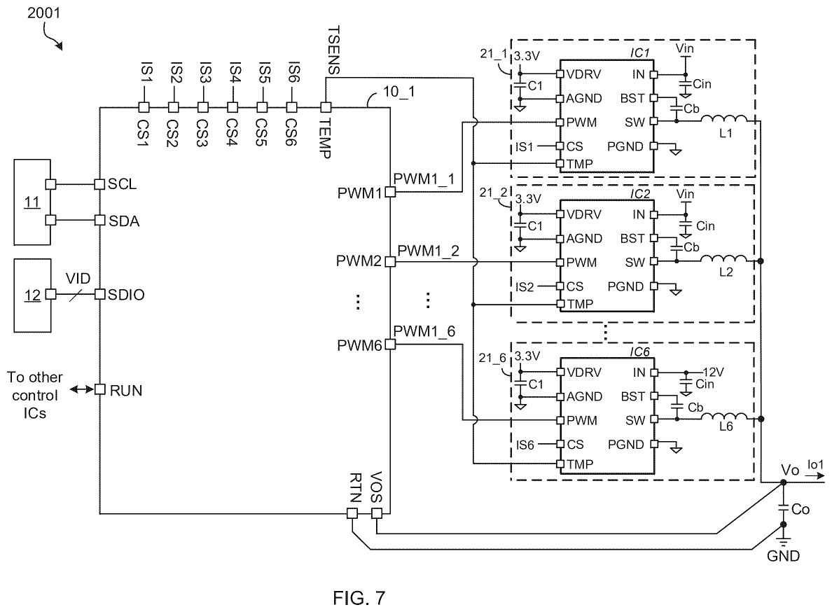

FIG. 7 schematically shows a circuit diagram of a multiphase switching converter 2001 in accordance with another embodiment of the present invention. The multiphase switching converter 2001 is a particular implementation of one of the multiphase switching converters 1001-1004. In the embodiment of FIG. 7, each switching circuit 21_j (j=1, 2, . . . , 6) has a power IC and an inductor. For example, a power IC IC1 and an inductor L1 form the switching circuit 21_1, a power IC IC2 and an inductor L2 form the switching circuit 21_2, and so on. The embodiment of FIG. 7 is illustrated employing six switching circuits as one example, and one with ordinary skill in the art should understand that the multiphase switching converter according to the embodiments of the present invention may also comprise different numbers of switching circuits.

In the example of FIG. 7, each of the power ICs IC1-IC6 has a voltage input pin IN to receive the input voltage Vin, a switch pin SW, a bootstrap pin BST, a logic power pin VDRV to receive logic power supply, a power ground pin PGND coupled to a power reference ground, a signal ground pin AGND coupled to a signal reference ground, a current sense output pin CS, a temperature report pin TMP, and a switching control input pin PWM. The power reference ground and the signal reference ground are coupled together on a print circuit board (PCB) to form the reference ground GND. In the example of FIG. 7, the logic power supply is 3.3V. A capacitor C1 is coupled between the logic power pin VDRV and the signal ground pin AGND of each power IC ICj (j=1, 2, . . . , 6), a capacitor Cb is coupled between the bootstrap pin BST and the switch pin SW of each power IC ICj, and a capacitor Cin is coupled between the voltage input pin IN and the power ground pin PGND of each power IC ICj. The switch pin SW of each power IC ICj provides the output voltage Vo via the corresponding inductor Lj (j=1, 2, . . . , 6), i.e., each inductor Lj has one terminal coupled to the corresponding switch pin SW of the power IC ICj and has another terminal to provide the output voltage Vo. An output capacitor Co is coupled between the output voltage Vo and the reference ground GND.

The switching control input pins PWM are configured to receive corresponding switching control signals. For example, the switching control input pin PWM of the power IC IC1 receives the switching control signal PWM1_1, the switching control input pin PWM of the power IC IC2 receives the switching control signal PWM1_2, and so on. The temperature report pins TMP are configured to report temperature information of the corresponding switching circuits. In one embodiment, the temperature report pins TMP of all the power ICs IC1-IC6 are coupled to the temperature sense pin TEMP of the control IC 10_1 to provide the temperature sense signal TSENS. The current sense output pin CS of each power IC ICj (j=1, 2, . . . , 6) outputs the corresponding current sense signal ISj (j=1, 2, . . . , 6) representing a current flowing through the corresponding switching circuit 21_j. For example, the current sense output pin CS of the power IC IC1 outputs the current sense signal IS1 representing the current flowing through the switching circuit 21_1, the current sense output pin CS of the power IC IC2 outputs the current sense signal IS2 representing the current flowing through the switching circuit 21_2, and so on.

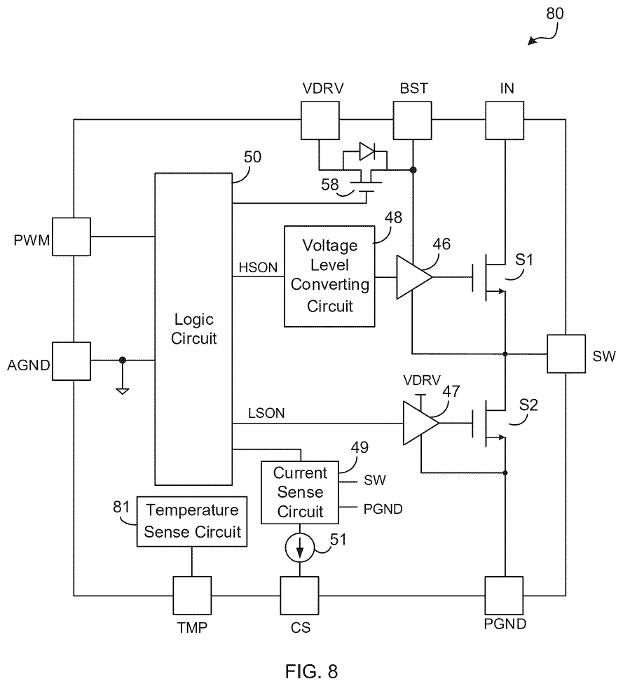

FIG. 8 schematically shows a circuit diagram of a power IC 80 in accordance with an embodiment of the present invention. The power IC 80 is a particular implementation of the power IC ICj (j=1, 2, . . . , 6) shown in FIG. 7. As shown in FIG. 8, the power IC 80 has a high side switch S1 and a low side switch S2. Each of the high side switch S1 and the low side switch S2 has a first terminal, a second terminal, and a control terminal. The first terminal of the high side switch S1 is coupled to the voltage input pin IN of the power IC 80, the second terminal of the high side switch S1 is coupled to the switch pin SW of the power IC 80, and the control terminal of the high side switch S1 is coupled to an output terminal of a driver circuit 46. The first terminal of the low side switch S2 is coupled to the switch pin SW of the power IC 80, the second terminal of the low side switch S2 is coupled to the power ground pin PGND of the power IC 80, and the control terminal of the low side switch S2 is coupled to an output terminal of a driver circuit 47. The bootstrap pin BST of the power IC 80 is coupled to the logic power pin VDRV of the power IC 80 via a switch 58. A logic circuit 50 is coupled to the switching control input pin PWM and the signal ground pin AGND of the power IC 80, and outputs a high side control signal HSON and a low side control signal LSON. The high side control signal HSON controls the high side switch S1 through the driver circuit 46 after a voltage level conversion performed by the voltage level converting circuit 48, and the low side control signal LSON controls the low side switch S2 through the driver circuit 47. A current sense circuit 49 senses a current flowing through the high side switch S1 or a current flowing through the low side switch S2, and provides a current sense signal at the current sense output pin CS. In one embodiment, a temperature sense circuit 81 senses the temperature of the power IC 80 and provides the temperature information of the power IC 80 at the temperature report pin TMP.

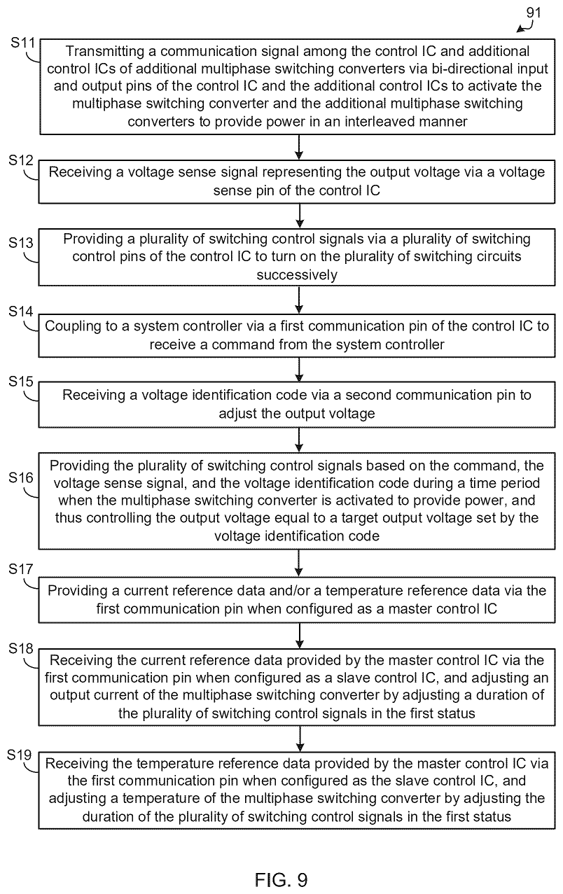

FIG. 9 illustrates a control method 91 for a multiphase switching converter in accordance with an embodiment of the present invention. The multiphase switching converter comprises a control integrated circuit (IC) and a plurality of switching circuits coupled together to provide an output voltage. The control method 91 comprises steps S11-S19.

In step S11, transmitting a communication signal among the control IC and additional control ICs of additional multiphase switching converters via bi-directional input and output pins of the control IC and the additional control ICs to activate the multiphase switching converter and the additional multiphase switching converters to provide power in an interleaved manner.

In step S12, receiving a voltage sense signal representing the output voltage via a voltage sense pin of the control IC.

In step S13, providing a plurality of switching control signals via a plurality of switching control pins of the control IC to turn on the plurality of switching circuits successively.

In step S14, coupling to a system controller via a first communication pin of the control IC to receive a command from the system controller.

In step S15, receiving a voltage identification code via a second communication pin to adjust the output voltage.

In step S16, providing the plurality of switching control signals based on the command, the voltage sense signal, and the voltage identification code during a time period when the multiphase switching converter is activated to provide power, and thus controlling the output voltage equal to a target output voltage set by the voltage identification code.

In step S17, providing a current reference data and/or a temperature reference data via the first communication pin when configured as a master control IC.

In step S18, receiving the current reference data provided by the master control IC via the first communication pin when configured as a slave control IC, and adjusting an output current of the multiphase switching converter by adjusting a duration of the plurality of switching control signals in the first status.

In step S19, receiving the temperature reference data provided by the master control IC via the first communication pin when configured as the slave control IC, and adjusting a temperature of the multiphase switching converter by adjusting the duration of the plurality of switching control signals in the first status.

Note that in the control method 91 described above, the functions indicated in the boxes can also occur in a different order than those shown in FIG. 9. For example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control integrated circuit (IC) of a multiphase switching converter, comprising:
a bi-directional input and output pin, operable to be coupled to additional control ICs of additional multiphase switching converters to transmit a communication signal, for activating the multiphase switching converter and the additional multiphase switching converters to provide power in an interleaved manner;
a voltage sense pin, configured to receive a voltage sense signal representing an output voltage of the multiphase switching converter; and
a plurality of switching control pins, configured to be respectively coupled to a plurality of switching circuits of the multiphase switching converter, wherein the control IC is configured to provide a plurality of switching control signals via the plurality of switching control pins based on the voltage sense signal to successively turn on the plurality of switching circuits during a time period when the multiphase switching converter is activated to provide power; wherein
the communication signal comprises an identification pulse and a synchronizing pulse, wherein the identification pulse is configured to transmit identity information of one of the control IC and the additional control ICs which is currently working, and the synchronizing pulse is configured to inform another one of the control IC and the additional control ICs to activate a corresponding one of the multiphase switching converter and the additional multiphase switching converters.

2. The control IC of claim 1, wherein:
during the time period when the multiphase switching converter is activated to provide power, the control IC is further configured to provide the identification pulse and the synchronizing pulse on the bi-directional input and output pin; and wherein
during a time period when one of the additional multiphase switching converters is activated to provide power, the control IC is further configured to receive the identification pulse and the synchronizing pulse via the bi-directional input and output pin.

3. The control IC of claim 1, wherein the identification pulse has a first pulse width, and the synchronizing pulse has a second pulse width.

4. The control IC of claim 1, further comprising:
a communication pin, configured to receive a voltage identification code to adjust the output voltage; and
a switching control circuit, configured to provide the plurality of switching control signals based on the voltage sense signal and the voltage identification code.

5. The control IC of claim 1, further comprising:
a comparison circuit, configured to provide a set signal based on the voltage sense signal and a voltage reference signal, wherein the voltage reference signal is provided based on a voltage identification code; wherein
during the time period when the multiphase switching converter is activated to provide power, the control IC is further configured to turn on the plurality of switching circuits successively based on the set signal; and wherein
during the time period when the multiphase switching converter is activated to provide power, the control IC is further configured to provide the identification pulse on the bi-directional input and output pin in response to at least one of the plurality of switching circuits being turned on by a corresponding switching control signal, and to provide the synchronizing pulse on the bi-directional input and output pin in response to at least a last switching circuit being turned on by a corresponding switching control signal.

6. The control IC of claim 1, further comprising:
a plurality of phase current sense pins, configured to receive a plurality of current sense signals, wherein each of the plurality of current sense signals represents a current flowing through the corresponding switching circuit;
a temperature sense pin, configured to receive a temperature sense signal; and
a current and temperature processing circuit, coupled to the plurality of phase current sense pins and the temperature sense pin, wherein the current and temperature processing circuit is configured to provide a current sense data based on the current sense signals and a temperature sense data based on the temperature sense signal; wherein
the control IC is further configured to adjust the plurality of switching control signals based on the current sense data and the temperature sense data, so as to balance the currents flowing through the plurality of switching circuits and achieve thermal balance or thermal management among the plurality of switching circuits.

7. A control integrated circuit (IC) of a multiphase switching converter, comprising:
a bi-directional input and output pin, operable to be coupled to additional control ICs of additional multiphase switching converters to transmit a communication signal, for activating the multiphase switching converter and the additional multiphase switching converters to provide power in an interleaved manner;
a first communication pin, operable to receive a command;
a second communication pin, operable to receive a voltage identification code;
a voltage sense pin, configured to receive a voltage sense signal representing an output voltage of the multiphase switching converter;
a plurality of switching control pins, configured to be respectively coupled to a plurality of switching circuits of the multiphase switching converter to output a plurality of switching control signals, so as to successively turn on the plurality of switching circuits during a time period when the multiphase switching converter is activated; and
a switching control circuit coupled to the plurality of switching control pins to provide the plurality of switching control signals based on the command, the voltage sense signal, and the voltage identification code.

8. The control IC of claim 7, wherein the communication signal comprises an identification pulse and a synchronizing pulse, and wherein:
the identification pulse is configured to transmit identity information of one of the control IC and the additional control ICs which is currently working, and the synchronizing pulse is configured to inform another one of the control IC and the additional control ICs to activate a corresponding one of the multiphase switching converter and the additional multiphase switching converters.

9. The control IC of claim 8, wherein:
during the time period when the multiphase switching converter is activated to provide power, the control IC is configured to provide the identification pulse and the synchronizing pulse on the bi-directional input and output pin; and wherein
during a time period when one of the additional multiphase switching converters is activated to provide power, the control IC is further configured to receive the identification pulse and the synchronizing pulse via the bi-directional input and output pin.

10. The control IC of claim 7, wherein during the time period when the multiphase switching converter is activated to provide power:
the switching control circuit is configured to turn on the plurality of switching circuits successively;
in response to at least one of the plurality of switching circuits being turned on by a corresponding switching control signal, the control IC is configured to provide an identification pulse on the bi-directional input and output pin for the additional control ICs to identify that the control IC is currently working; and
in response to at least a last switching circuit being turned on by a corresponding switching control signal, the control IC is further configured to provide a synchronizing pulse on the bi-directional input and output pin to inform one of the additional control ICs to be ready to activate a corresponding one of the additional multiphase switching converters.

11. A control method for a power supply system, wherein the power supply system comprises a first multiphase switching converter and a second multiphase converter coupled in parallel to provide an output voltage, the control method comprising:
transmitting a communication signal between a first control integrated circuit (IC) of the first multiphase switching converter and a second control IC of the second multiphase switching converter, to activate the first multiphase switching converter and the second multiphase switching converter to provide power in an interleaved manner;
receiving a voltage sense signal representing the output voltage by the first control IC and the second control IC;
receiving a voltage identification code by the first control IC and the second control IC for adjusting the output voltage;
providing a first plurality of switching control signals by the first control IC based on the voltage sense signal and the voltage identification code, to successively turn on a first plurality of switching circuits of the first multiphase switching converter during a time period when the first multiphase switching converter is activated to provide power; and
providing a second plurality of switching control signals by the second control IC based on the voltage sense signal and the voltage identification code, to successively turn on a second plurality of switching circuits of the second multiphase switching converter during a time period when the second multiphase switching converter is activated to provide power.

12. The control method of claim 11, wherein the communication signal comprises an identification pulse and a synchronizing pulse, and wherein:
during a time period when the first multiphase switching converter is activated to provide power, the first control IC is configured to provide the identification pulse and the synchronizing pulse; and
during a time period when the second multiphase switching converter is activated to provide power, the second control IC is configured to provide the identification pulse and the synchronizing pulse.

13. The control method of claim 12, wherein:
during the time period when the first multiphase switching converter is activated to provide power, the identification pulse provided by the first control IC has a first pulse width;
during the time period when the second multiphase switching converter is activated to provide power, the identification pulse provided by the second control IC has a second pulse width; and wherein
the synchronizing pulse has a third pulse width.

14. The control method of claim 11, further comprising:
providing a current reference data by the first control IC to adjust an output current of the second multiphase switching converter controlled by the second control IC; and
receiving the current reference data by the second control IC to adjust the output current of the second multiphase switching converter based on the current reference data.

15. The control method of claim 11, further comprising:
providing a temperature reference data by the first control IC to adjust a temperature of the second multiphase switching converters controlled by the second control IC; and
receiving the temperature reference data by the second control IC to adjust the temperature of the second multiphase switching converter based on the temperature reference data.

16. A power supply system, comprising:
a first multiphase switching converter, comprising a first plurality of switching circuits coupled in parallel and a first control integrated circuit (IC), wherein the first control IC comprises a first bi-directional input and output pin and a first plurality of switching control pins, and wherein the first plurality of switching control pins are configured to provide a first plurality of switching control signals to control the first plurality of switching circuits; and
a second multiphase switching converter, comprising a second plurality of switching circuits coupled in parallel and a second control IC, wherein the second control IC comprises a second bi-directional input and output pin and a second plurality of switching control pins, and wherein the second plurality of switching control pins are configured to provide a second plurality of switching control signals to control the second plurality of switching circuits; wherein
the first bi-directional input and output pin and the second bi-directional input and output pin are coupled together to transmit information between the first control IC and the second control IC for controlling the first multiphase switching converter and the second multiphase switching converter to provide power in an interleaved manner.

17. The power supply system of claim 16, wherein:
during a time period when the first multiphase switching converter is activated to provide power, the first control IC is configured to provide an identification pulse via the first bi-directional input and output pin for the second control IC to identify that the first control IC is currently working; and wherein
during a time period when the second multiphase switching converter is activated to provide power, the second control IC is configured to provide the identification pulse via the second bi-directional input and output pin for the first control IC to identify that the second control IC is currently working.

18. The power supply system of claim 17, wherein:
during the time period when the first multiphase switching converter is activated to provide power, the first control IC is further configured to turn on the first plurality of switching circuits successively and to provide the identification pulse in response to at least one of the first plurality of switching circuits being turned on by a corresponding one of the first plurality of switching control signals.

19. The power supply system of claim 16, wherein:
during a time period when the first multiphase switching converter is activated to provide power, the first control IC is configured to provide a synchronizing pulse via the first bi-directional input and output pin to inform the second control IC to activate the second multiphase switching converter to provide power.

20. The power supply system of claim 19, wherein:
during the time period when the first multiphase switching converter is activated to provide power, the first control IC is further configured to turn on the first plurality of switching circuits successively and to provide the synchronizing pulse in response to at least a last one of the first plurality of switching circuits being turned on by a corresponding one of the first plurality of switching control signals.
